(19) United States
(12) Patent Application Publication
(10) Pub. No.: US 2020/0273073 A1
(43) Pub. Date: Aug. 27, 2020

(54) INFORMATION PROVIDING DEVICE, INFORMATION PROVIDING METHOD, AND STORAGE MEDIUM

(71) Applicant: HONDA MOTOR CO., LTD., Tokyo (JP)

(72) Inventor: Ryo Takebayashi, Wako-shi (JP)

(21) Appl. No.: 16/790,781

(22) Filed: Feb. 14, 2020

(30) Foreign Application Priority Data
Feb. 26, 2019 (JP) 2019-032717

(51) Int. Cl. G06Q 30/02; G06K 9/00

(52) U.S. Cl. CPC G06Q 30/0269; G06Q 30/0265; G06K 9/00255; G06K 9/00288

(57) ABSTRACT

An information providing device includes: an outputter configured to output information; a communicator configured to communicate with other devices; an inputter configured to be operated by a user of a vehicle; a first acquirer configured to acquire biological information of the user; a second acquirer configured to acquire position information of the vehicle; a first determiner configured to determine a communication mode of the communicator on the basis of an operation input to the inputter; a communication controller configured to cause the communicator to transmit the biological information and the position information to the other devices in a case in which the communication mode is determined to be a first mode by the first determiner; and an output controller configured to cause the outputter to output promotion information for urging the user to input a first operation for causing the first determiner to determine the first mode to the inputter.

### CROSS-REFERENCE TO RELATED APPLICATION

The present application claims priority based on Japanese Patent Application No. 2019-032717, filed on Feb. 26, 2019, the content of which is incorporated herein by reference.

### BACKGROUND

### Field of the Invention

The present invention relates to an information providing device, an information providing method, and a storage medium.

### Description of Related Art

A technology for perceiving a market trend by detecting a face, a facial expression, a driving operation, and the like of a driver getting in a trial vehicle and calculating customer satisfaction on the basis of detection results and a traveling status of the trial vehicle is known (for example, see Japanese Unexamined Patent Application, First Publication No. 2004-178071). In recent years, applications to various advanced technologies performed by collecting biological information of users of vehicles as big data and analyzing the big data have been researched.

### SUMMARY

However, in conventional technology, there are cases in which biological information to be handled as personal information such as a face image and a voice is provided for a third party without consent of the person, and there are cases in which a user refuses to provide biological information. As a result, there are cases in which development of advanced technologies is inhibited.

An aspect of the present invention is in view of such situations, and one object thereof is to provide an information providing device, an information providing method, and a storage medium capable of promoting development of advanced technologies by causing users to actively provide personal information.

An information providing device, an information providing method, and a storage medium according to the present invention employ the following configurations.

(1) One aspect of the present invention is an information providing device including: an outputter that outputs information; a communicator that communicates with other devices; an inputter to which an operation of a user of a vehicle is input; a first acquirer that acquires biological information of the user; a second acquirer that acquires position information of the vehicle; a determiner that determines a communication mode of the communicator on the basis of an operation input to the inputter; a communication controller that causes the communicator to transmit the biological information acquired by the first acquirer and the position information acquired by the second acquirer to the other devices in a case in which the communication mode is determined to be a first mode by the determiner; and an output controller that causes the outputter to output promotion information for urging the user to input a first operation for causing the determiner to determine the first mode to the inputter.

According to an aspect (2), in the information providing device according to the aspect (1) described above, the output controller causes the outputter to output information indicating that an incentive is given to the user when the first operation is input to the inputter as the promotion information.

According to an aspect (3), in the information providing device according to the aspect (1) or (2) described above, the first acquirer acquires at least one of image information of the user imaged by a camera and voice information of the user received by a microphone as the biological information.

According to an aspect (4), in the information providing device according to the aspect (3) described above, the first mode is a mode permitting transmission of the image information, the voice information, and the position information, a second mode prohibiting transmission of at least one of the image information, the voice information, and the position information is additionally included among communication modes in addition to the first mode, and the output controller causes the outputter to output information indicating that a first incentive is given to the user when the first operation is input to the inputter as the promotion information and causes the outputter to output information indicating that a second incentive different form the first incentive is given to the user when a second operation for causing the determiner to determine the second mode is input to the inputter as the promotion information.

According to an aspect (5), in the information providing device according to the aspect (4) described above, types of the first incentive and the second incentive are different from each other.

According to an aspect (6), in the information providing device according to the aspect (4) or (5) described above, the first incentive is an incentive that more easily induces the first operation than the second incentive.

According to an aspect (7), in the information providing device according to any one of the aspects (1) to (6) described above, the determiner determines the communication mode to be a third mode in a case in which a new user boards the vehicle under the first mode, and the communication controller causes the communicator to stop transmission of at least the biological information in a case in which the communication mode is determined to be the third mode by the determiner.

According to an aspect (8), in the information providing device according to the aspect (7) described above, the output controller causes the outputter to output promotion information for urging the user who has newly boarded the vehicle to input the first operation to the inputter.

According to an aspect (9), the information providing device according to any one of the aspects (1) to (8) described above further includes a second determiner that determines whether or not predetermined information is included in the biological information, and the communication controller causes the communicator to transmit the biological information and the position information on the basis of a result of judgment according to the second determiner.

According to an aspect (10), in the information providing device according to any one of the aspects (1) to (9) described above, the determiner determines the communication mode on the basis of an operation input to the inputter by each of a plurality of users in a case in which the plurality of users are in the vehicle.

According to an aspect (11), in the information providing device according to any one of the aspects (1) to (10) described above, the communicator controller causes the communicator to transmit the biological information, the position information, and information for permitting information provision for a third party in a case in which a third operation permitting provision of at least one of the biological information and the position information for the third party other than a provider that has provided the vehicle for the user and the third party is input to the inputter.

(12) According to another aspect invention, there is provided an information providing method using a computer mounted in a vehicle including an outputter that outputs information, a communicator that communicates with other devices, and an inputter to which an operation of a user of the vehicle is input, the information providing method including: acquiring biological information of the user; acquiring position information of the vehicle; determining a communication mode of the communicator on the basis of an operation input to the inputter; causing the communicator to transmit the biological information and the position information to the other devices in a case in which the communication mode is determined to be a first mode; and causing the outputter to output promotion information for urging the user to input a first operation for determining the first mode to the inputter.

(13) According to further another aspect of the present invention, there is provided a computer-readable non-transitory storage medium storing a program causing a computer mounted in a vehicle including an outputter that outputs information, a communicator that communicates with other devices, and an inputter to which an operation of a user of the vehicle is input to execute: a process of acquiring biological information of the user; a process of acquiring position information of the vehicle; a process of determining a communication mode of the communicator on the basis of an operation input to the inputter; a process of causing the communicator to transmit the biological information and the position information to the other devices in a case in which the communication mode is determined to be a first mode; and a process of causing the outputter to output promotion information for urging the user to input a first operation for determining the first mode to the inputter.

According to the aspects (1) to (13), development of advanced technologies can be promoted by causing users to actively provide personal information.

### BRIEF DESCRIPTION OF THE DRAWINGS

FIG. 1 is a diagram showing one example of the configuration of an information providing system according to a first embodiment;

FIG. 2 is a sequence diagram showing the flow of a series of processes of the information providing system according to the first embodiment;

FIG. 3 is a diagram showing one example of the configuration of an information providing device according to the first embodiment;

FIG. 4 is a diagram showing one example of the vehicle cabin of a subject vehicle M seen from a driver seat;

FIG. 5 is a flowchart showing the flow of a series of processes of the information providing device according to the first embodiment;

FIG. 6 is a diagram showing one example of a provision intention checking screen;

FIG. 7 is a diagram of the inside of a subject vehicle seen from above;

FIG. 8 is a diagram showing one example of a display screen of a policy relating to provision of personal information;

FIG. 9 is a diagram showing one example of the configuration of a server apparatus according to a first embodiment;

FIG. 10 is a flowchart showing the flow of a series of processes of a server apparatus according to the first embodiment;

FIG. 11 is a flowchart showing the flow of a series of processes of an information providing device according to a second embodiment;

FIG. 12 is a diagram of the vehicle cabin of a subject vehicle seen from above;

FIG. 13 is a diagram showing one example of a provision intention checking screen displayed for a vehicle occupant newly boarding a subject vehicle;

FIG. 14 is a diagram showing one example of a history of acquisition of personal information;

FIG. 15 is a diagram showing one example of a provision target selection screen;

FIG. 16 is a diagram showing one example of a protection level selection screen;

FIG. 17 is a flowchart showing the flow of a series of processes of a server apparatus according to a third embodiment;

FIG. 18 is a diagram showing a method of determining an incentive; and

FIG. 19 is a flowchart showing the flow of a series of processes of an information providing device according a fourth embodiment.

### DESCRIPTION OF EMBODIMENTS

Hereinafter, an information providing device, an information providing method, and a storage medium according to embodiments of the present invention will be described with reference to the drawings.

### First Embodiment

### [System Configuration]

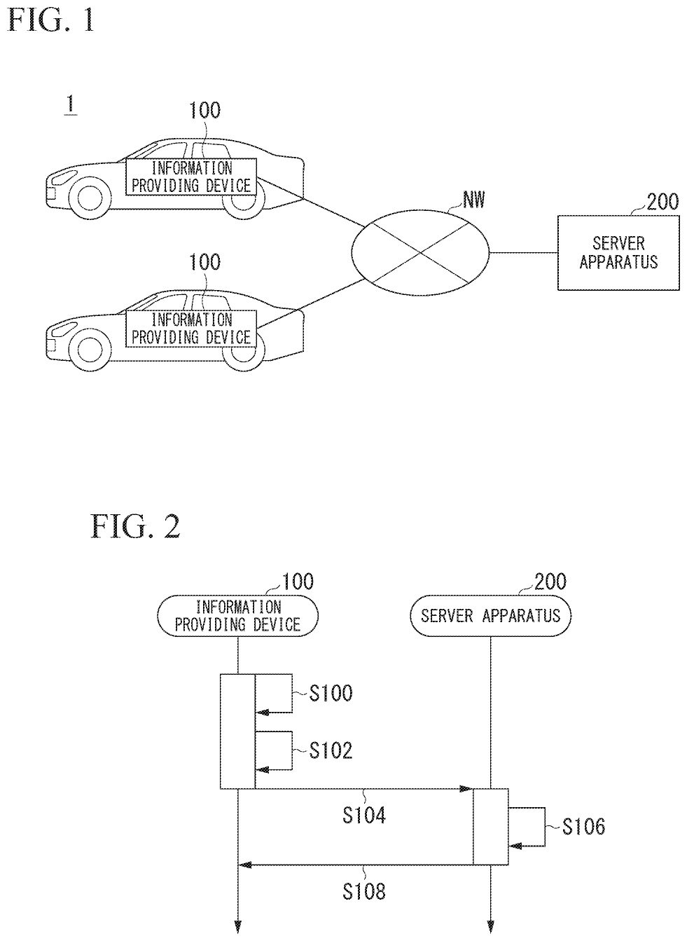

FIG. 1 is a diagram showing one example of the configuration of an information providing system 1 according to a first embodiment. The information providing system according to the first embodiment, for example, includes a plurality of information providing devices 100 and a server apparatus 200. As in the example illustrated in the drawing, each information providing device 100 is mounted in a vehicle. For example, the vehicle is a vehicle having two wheels, three wheels, four wheels, or the like. A driving source of such a vehicle may be an internal combustion engine such as a diesel engine or a gasoline engine, an electric motor, or a combination thereof. The electric motor operates using power generated using a power generator connected to an internal combustion engine or power discharged from a secondary cell or a fuel cell.

The vehicle in which the information providing device 100 is mounted may be a vehicle such as a rent-a-car, a taxi, or a bus for the purpose of being used by a plurality of unspecified users or a vehicle that is commonly used by certain specific users through a car sharing service or the like.

The devices included in the information providing system are communicatively connected to each other through a network NW. A local area network (LAN), a wide area network (WAN), and the like are included in the network NW. For example, a network using radio communication such as Wi-Fi or Bluetooth (a registered trademark; hereinafter, it will be omitted) may be included in the network NW.

The information providing device 100 collects biological information such as a face image and a voice of a user boarding a vehicle (hereinafter, referred to as a subject vehicle M) in which the device is mounted and position information of the subject vehicle M and provides information such as a part or all of the biological information and the position information that have been collected and an occupant's feeling and a driver's status that are generated or processed on the basis of at least the biological information for the server apparatus 200 and the like. At this time, the information providing device 100 request a user to agree to the provision of the biological information and the position information for other devices. More specifically, the information providing device 100 urges a user to agree to the provision of biological information by guiding the user that an incentive is given when the provision of the biological information and the position information is agreed.

For example, in a case in which a vehicle in which the information providing device 100 is mounted is a vehicle for which it is necessary to pay a monetary value when the vehicle is used such as a rent-a-car, a taxi, a bus, or a sharing car, in other words, in a case in which it takes a usage fee of a vehicle, the incentive is part or the whole of the usage fee being paid back in cash or points. Points given as an incentive may be used for the payment of a usage fee of a vehicle or may be used for the payment of a usage fee of another service such as shopping. The incentive may be a coupon, a ticket, a discount coupon or the like bringing an effect similar to that of points, a right for renting a vehicle with priority, or the like.

The server apparatus 200, for example, is an apparatus used by a company that provides vehicles such as rent-a-cars, taxies, buses, and sharing cars for users. For example, in a case in which a vehicle providing company is a rent-a-car company, in a case in which a user of a vehicle that has been rented agrees to the provision of biological information, the server apparatus 200 acquires the biological information of the user and the position information of the vehicle from the information providing device 100 mounted in the vehicle. The server apparatus 200 determines an incentive to be given to a user who has agreed to the provision of information on the basis of the biological information and the position information acquired from the information providing device 100. When the acquired information can be secondarily provided for a third party such as a collage, a research institution, a company, or an individual, the server apparatus 200 provides the acquired information for the third party.

### [Sequence of Information Providing System]

FIG. 2 is a sequence diagram showing the flow of a series of processes of the information providing system 1 according to the first embodiment. First, the information providing device 100 collects biological information of a user boarding a subject vehicle M and position information of the subject vehicle M (Step S100).

Next, the information providing device 100 determines whether or not the user has agreed to the provision of the biological information and the position information (Step S102) and transmits various types of information that has been collected to the server apparatus 200 in a case in which the user has agreed to the provision of the biological information and the position information (Step S104).

When the biological information and the position information are received from the information providing device 100, the server apparatus 200 determines an incentive given to a user who has agreed to the provision of information (Step S106).

Next, the server apparatus 200 notifies the information providing device 100 that is a transmission source of the information that the incentive has been given to the user who has agreed to the provision of information (Step S108).

### [Configuration of Information Providing Device]

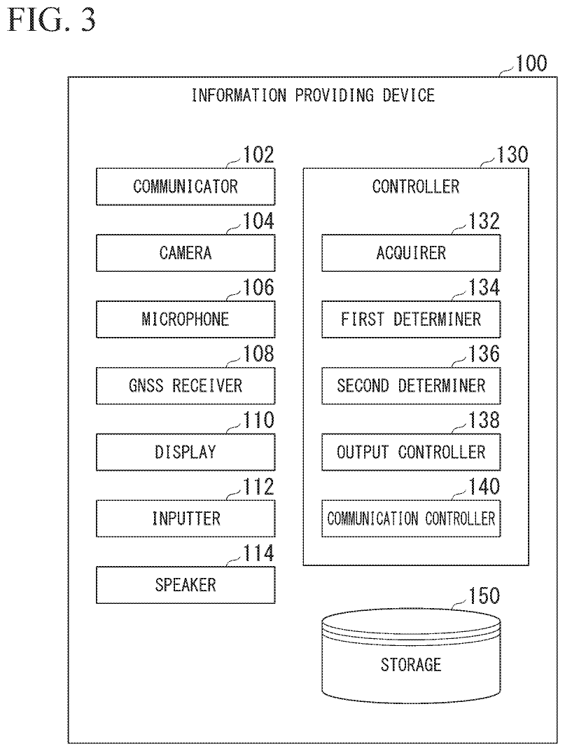

FIG. 3 is a diagram showing one example of the configuration of an information providing device 100 according to the first embodiment. The information providing device 100 according to the first embodiment, for example, includes a communicator 102, a camera 104, a microphone 106, a global navigation satellite system (GNSS) receiver 108, a display 110, an inputter 112, a speaker 114, a controller 130, and a storage 150. Such devices and units may be connected to each other using a multiple communication line such as a controller area network (CAN) communication line, a serial communication line, a radio communication network, or the like. The configuration of the information providing device 100 illustrated in FIG. 3 is merely one example, and thus, part of the configuration may be omitted, and a different configuration may be further added.

For example, the communicator 102 includes an antenna and a communication interface such as a network interface card (NIC). The communicator 102 communicates with the server apparatus 200 and the like through a network NW.

The camera 104 is a camera that images the inside of the vehicle cabin of the subject vehicle M. The camera 104, for example, is a digital camera using a solid-state imaging device such as a charge coupled device (CCD) or a complementary metal oxide semiconductor (CMOS). When the inside of the vehicle cabin of the subject vehicle M is imaged, the camera 104 generates image data and outputs this image data to the controller 130. For example, the image data may be a still image or a moving image (video) in which still images are continuous in a time series.

The microphone 106 is a voice input device that receives a voice inside the vehicle cabin of the subject vehicle M. The microphone 106 outputs voice data that has been received to the controller 130. For example, the microphone 106 is installed near an instrument panel positioned on a front side when an occupant sits on a seat inside the vehicle cabin. The microphone 106 may be installed near a mat lamp, a steering wheel, or a seat. A plurality of microphones 106 may be installed inside the vehicle cabin.

The GNSS receiver 108 identifies the position of the subject vehicle M on the basis of radiowaves received from GNSS satellites. When the position of the subject vehicle M is identified, the GNSS receiver 108 outputs the position information to the controller 130.

The display 110 includes a display device such as a liquid crystal display (LCD), an organic electroluminescence (EL) display, or the like. The display 110 displays an image on the basis of information output by the controller 130. The display 110 is one example of an “outputter”.

The inputter 112, for example, is a user interface such as a touch button, a keyboard, or a mouse. The inputter 112 accepts an occupant's operation and outputs a signal corresponding to the accepted operation to the controller 130. The inputter 112 may be a touch panel that is configured integrally with the display 110.

The speaker 114, for example, is installed near a seat or the display 110 inside the vehicle cabin. The speaker 114 outputs a voice on the basis of information output by the controller 130. The speaker 114 is another example of an “outputter”.

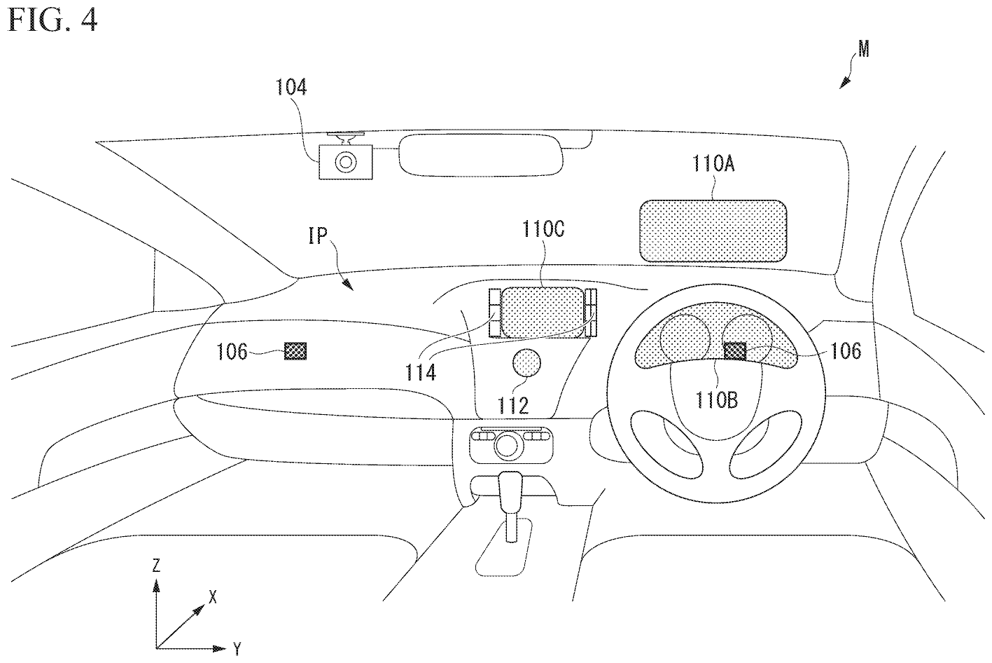

FIG. 4 is a diagram showing one example of the vehicle cabin of a subject vehicle M seen from a driver seat. Inside the vehicle cabin illustrated in the example, a camera 104, a microphone 106, displays 110A to 110C, and a speaker 114 are installed.

The camera 104, for example, is installed near a roof or a front windshield inside the vehicle cabin and images faces and the like of occupants sitting on seats. The microphone 106 is disposed on a side in front of each seat. For example, the microphone 106 is disposed on a steering wheel in a case in which a voice of an occupant sitting on a driver seat is to be received.

For example, the display 110A is a head-up display (HUD) device displaying a virtual image at the tip of a visual line when a driver visually recognizes the outside of the vehicle. For example, the HUD device is a device that allows an occupant to visually recognize a virtual image by causing light to pass through a front windshield of the subject vehicle M or a transparent member having a light transmitting property called a combiner. An occupant who is a target for visual recognition of a virtual image is mainly a driver but may be an occupant other than the driver.

The display 110B is disposed in an instrument panel IP near a front face of a driver seat (a seat closest to the steering wheel) and is installed at a position that can be visually recognized by an occupant through a gap of the steering wheel or over the steering wheel. The display 110B, for example, is an LCD, an organic EL display device, or the like. For example, images of a speed, an engine speed, a remaining amount of fuel, a water temperature of a radiator, a travel distance, and other information of the subject vehicle M are displayed on the display 110B.

The display 110C is installed near the center of the instrument panel IP. For example, similar to the display 110B, the display 110C is an LCD, an organic EL display device, or the like. The display 110C displays contents such as a television program and a movie.

For example, the speaker 114 is installed near the display 110C, in other words, near the center of the instrument panel IP.

Returning to the description of FIG. 3, the controller 130, for example, includes an acquirer 132, a first determiner 134, a second determiner 136, an output controller 138, and a communication controller 140.

Each of such constituent elements, for example, is realized by a hardware processor such as a central processing unit (CPU) or a graphic processing unit (GPU) executing a program (software). Some or all of these constituent elements may be realized by hardware (a circuit; including circuitry) such as a large scale integration (LSI), an application specific integrated circuit (ASIC), or a field-programmable gate array (FPGA) or may be realized by software and hardware in cooperation. The program may be stored in the storage 150 in advance or may be stored in a storage medium such as a DVD or a CD-ROM that can be loaded or unloaded and installed in the storage 150 by loading the storage medium in a drive device.

The storage 150 is realized by an HDD, a flash memory, an electrically erasable programmable read only memory (EEPROM), a read only memory (ROM), a random access memory (RAM), or the like. For example, a program and the like that are referred to by a processor are stored in the storage 150.

The acquirer 132 acquires face image data of an occupant from the camera 104, acquires voice data of an occupant from the microphone 106, and acquires position information of the subject vehicle M from the GNSS receiver 108. Hereinafter, information including at least one piece of the face image data of an occupant or voice data will be referred to as biological information of the occupant in description. The acquirer 132 may further acquire fingerprint data, palm print data, iris data, vein data, or the like of an occupant from various sensors (not illustrated in the drawing) in addition to the face image data and the voice data of the occupant as biological information. The acquirer 132 is one example of a “first acquirer” and a “second acquirer”.

The first determiner 134 determines a communication mode of the communicator 102 on the basis of an operation on the inputter 112 input by an occupant. For example, an information provision mode MD1 permitting the communicator 102 to transmit information or data and an information non-provision mode MD2 prohibiting the communicator 102 from transmission information or data are included in the communication mode.

The second determiner 136 determines whether or not inappropriate information is included in biological information acquired by the acquirer 132. The inappropriate information, for example, is personal information of an occupant, information that is not desired to be provided for other people by an occupant, and the like. For example, in a case in which an occupant mentioned his or other person's telephone number, credit card number, or the like inside a vehicle, the second determiner 136 determines that inappropriate information is included in voice data acquired as biological information. In a case in which an occupant is boarding the subject vehicle M in a posture or appearance not desired to be seen by other people, the second determiner 136 determines that inappropriate information is included in image data acquired as biological information.

The output controller 138 causes the display 110 to display information for urging an occupant of the subject vehicle M to input an operation for causing the first determiner 134 to determine the communication mode of the communicator 102 to be the information provision mode MD1 on the inputter 112 as an image or causes the speaker 114 to output the information as a voice.

In a case in which the communication mode of the communicator 102 is determined to be the information provision mode MD1 by the first determiner 134, the communication controller 140 causes the communicator 102 to transmit the biological information and the position information acquired by the acquirer 132 to the server apparatus 200. At this time, the information providing device 100 may perform pre-processing of encryption and the like such that an individual cannot be identified from the transmitted information. Similar pre-processing is performed also by the server apparatus 200 such that an individual cannot be identified from the received information and then manages the information. In a case in which a relay device toward the network NW such as a smartphone or an access point is present inside the subject vehicle M, and communication with the server apparatus 200 is performed through the relay device, the communication controller 140 may cause the communicator 102 to transmit the biological information and the position information acquired by the acquirer 132 to the server apparatus 200 through the relay device. The server apparatus 200 or the relay device is one example of “another device”.

Also when the communication mode of the communicator 102 is the information provision mode MD1, in a case in which inappropriate information is determined to be included in the biological information by the second determiner 136, the communication controller 140 causes the communicator 102 to stop transmission of at least the biological information out of the biological information and the position information.

### [Process Flow of Information Providing Device]

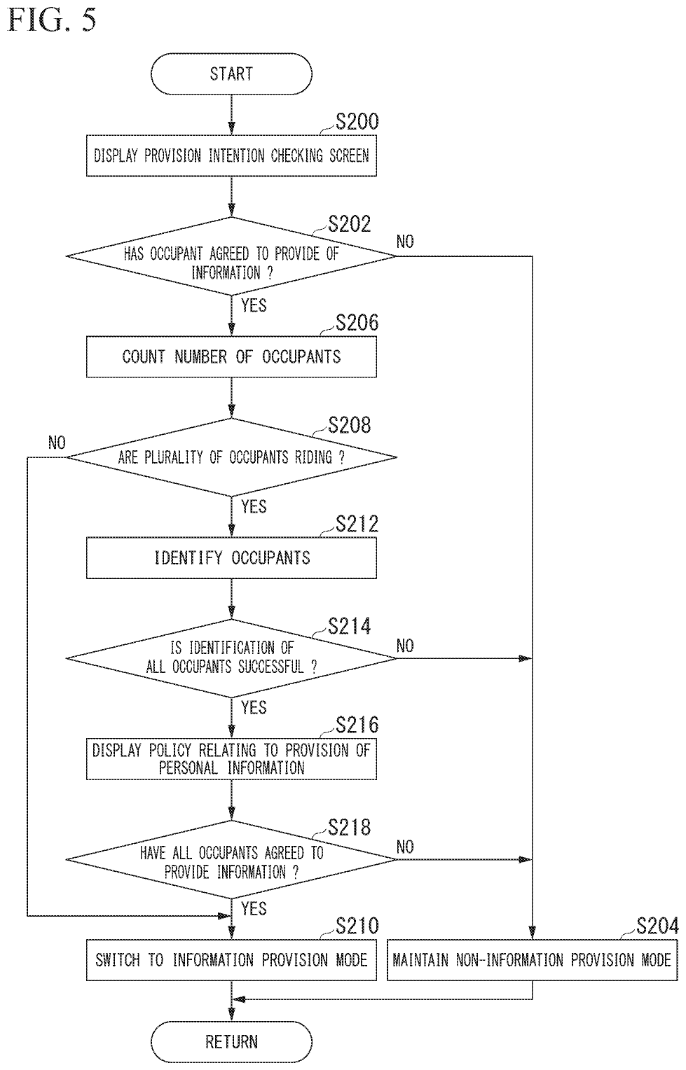

Hereinafter, the flow of a series of processes of the information providing device 100 according to the first embodiment will be described with reference to a flowchart. FIG. 5 is a flowchart showing the flow of a series of processes of the information providing device 100 according to the first embodiment. The process of this flowchart, for example, may be repeatedly performed at a predetermined period on an initial setting scene. For example, the initial setting scene is a scene in which, when a subject vehicle M that is parked starts, an accessory power supply and an ignition power supply of the subject vehicle M come into on states, and the information providing device 100 receives the supply of electric power from the power supplies and starts. In the initial setting scene, in other words, in an initial state in which the subject vehicle receives the supply of electric power and starts, the communicator 102 is assumed to be in the information non-provision mode MD2 as a principle.

First, the output controller 138 causes the display 110 to display a screen (hereinafter, referred to as a provision intention checking screen) used for checking that there is an intention for agreeing to the provision of biological information and position information (Step S200). Hereinafter, the display 110 will be described as being a touch panel integrated with the inputter 112.

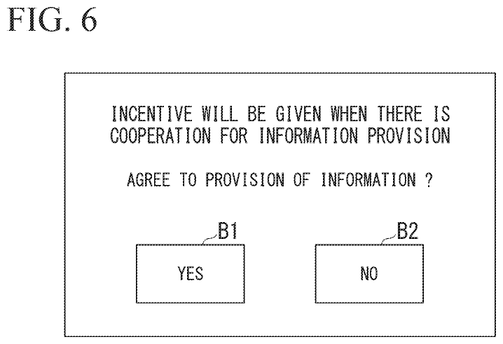

FIG. 6 is a diagram showing one example of the provision intention checking screen. As in the example illustrated in the drawing, the output controller 138 causes the output controller 138 to display texts and an image indicating that an incentive such as cash back using cash or a discount of a usage fee will be given to the provider (in other words, an occupant) in a case in which biological information and position information are provided on the screen of the display 110. At this time, the output controller 138 may cause the speaker 114 to output that an incentive is given in accordance with provision of information as a voice guidance. The provision intention checking screen in which texts and an image indicating that an incentive is given are included is one example of “promotion information”. At this time, display indicating that personal information is kept in secret (provided information and an individual are not linked to each other) even in a case in which provision of information is performed by a provider, and display of description of a policy to be described later and handling of provided personal information and link information toward the description may be performed.

Next, the second determiner 136 determines whether an occupant has agreed to the provision of the biological information and the position information (Step S202). For example, the second determiner 136 determines that the occupant has agreed to the provision of the biological information and the position information in a case in which a button B1 representing agreement to the provision of the information is operated on the provision intention checking screen and determines that the occupant has not agreed to the provision of the biological information and the position information in a case in which a button B2 indicating no agreement to the provision of the information is operated or a predetermined time has elapsed without any button operated on the provision intention checking screen. An operation on the button B1 indicating agreement to the provision of the information on the provision intention checking screen is one example of a “first operation”.

In a case in which the occupant has not agreed to the provision of the biological information and the position information, in other words, in a case in which the button B1 has not been operated on the provision intention checking screen, the first determiner 134 maintains the communication mode of the communicator 102 as being the information non-provision mode MD2 (Step S204). In a case in which the communication mode of the communicator 102 is any other mode such as the information provision mode MD1, the first determiner 134 may switch the communication mode of the communicator 102 from the other mode to the information non-provision mode MD2. In a case in which the communication mode is maintained as being the information non-provision mode MD2, or switching from the other mode to the information non-provision mode MD2 is performed, the communication controller 140 does not transmit the biological information and the position information to the server apparatus 200 through the communicator 102. In a case in which the communication mode is the information non-provision mode MD2, the communication controller 140 may transmit the position information to the server apparatus 200.

On the other hand, in a case in which an occupant agrees to the provision of the biological information and the position information, in other words, in a case in which the button B1 has been operated on the provision intention checking screen, the second determiner 136 counts the number of occupants boarding the subject vehicle M (Step S206). For example, by analyzing image data generated by the camera 104, the second determiner 136 counts the number of occupants present inside the subject vehicle M.

Next, the second determiner 136 determines whether or not a plurality of occupants are boarding the subject vehicle M in accordance with the counted number of occupants (Step S208). For example, in a case in which the number of occupants is one, the second determiner 136 determines that a plurality of occupants have not boarded the subject vehicle M, and only an occupant who has agreed to the provision of information has boarded. On the other hand, in a case in which the number of occupants is two or more, the second determiner 136 determines that a plurality of occupants are boarding the subject vehicle M, and an occupant who has not agreed to the provision of information is also boarding addition to the occupant who has agreed to the provision of information.

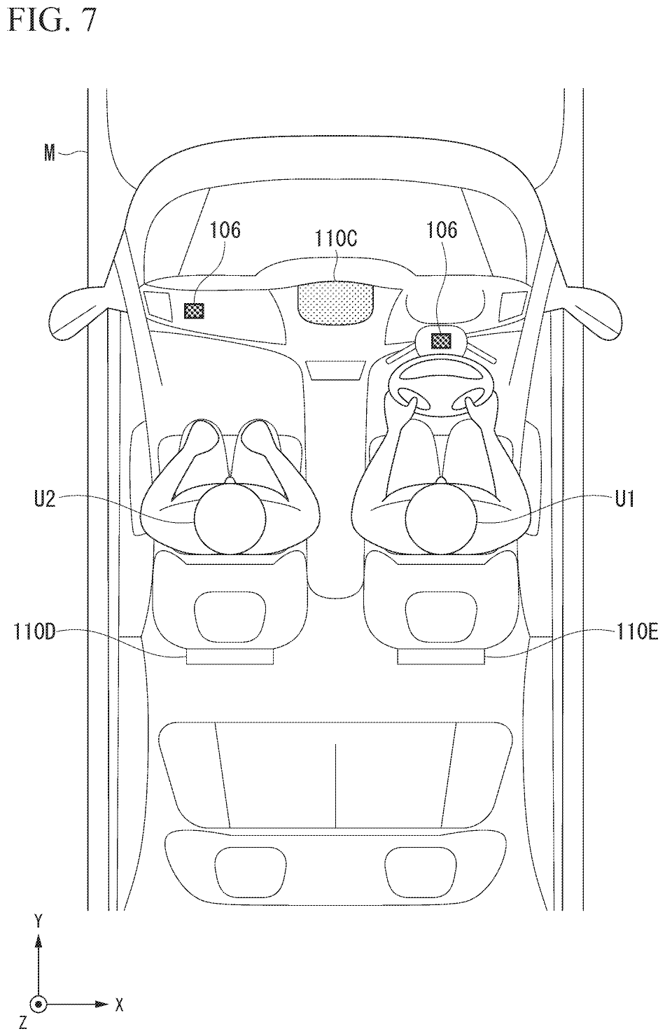

FIG. 7 is a diagram of the inside of a subject vehicle M seen from above. In the example illustrated in the drawing, an occupant U1 is sitting on a driver seat, and an occupant U2 is sitting on an assistant driver's seat. For this reason, the second determiner 136 determines that a plurality of occupants are boarding the subject vehicle M. Dedicated displays 110D and 110E may be attached to rear faces of the driver seat and the assistant driver's seat for occupants sitting on rear seats. Similar to the displays 110B and 110C, each of the displays 110D and 110E may be an LCD, an organic EL display device, or the like.

In a case in which a plurality of occupants are not boarding the subject vehicle M, it can be regarded that one occupant boarding the subject vehicle M has already agreed to the provision of information, and accordingly, the first determiner 134 switches the communication mode of the communicator 102 from the information non-provision mode MD2 to the information provision mode MD1 (Step S210). In accordance with this, the communication controller 140 causes the communicator 102 to transmit the biological information and the position information to the server apparatus 200. A timing at which the biological information and the position information are transmitted may be any timing as long as the timing is after the agreement of the occupant to the provision of information. For example, the communication controller 140 may transmit the biological information and the position information at a timing at which the occupant agrees to the provision of information, may transmit the biological information and the position information at a timing at which all the occupants get off the subject vehicle M, or may transmit the biological information and the position information after a period of a certain degree has elapsed such as at the end of one day, at the end of a week, or at the end of a month. During such a period, the biological information and the position information are not transmitted to the server apparatus 200 but stored (saved) in the storage 150.

On the other hand, in a case in which a plurality of occupants are boarding the subject vehicle M, it can be regarded that other occupants other than the occupant who has already agreed to the provision of information are boarding the subject vehicle M, and accordingly, the second determiner 136 identifies all the occupants boarding the subject vehicle M (Step S212).

For example, by performing biometric identification using characteristics of a face, characteristics of a sound, and the like, the second determiner 136 determines whether or not the plurality of occupants boarding the subject vehicle M are occupants registered in advance. Here, “an occupant registered in advance”, for example, is an occupant who has registered a contact point or the like when renting a rent-a-car or the like, an occupant who has been registered in a service such as car sharing as a member, or the like.

By causing the display 110 to display a screen for inputting person-specific information such as a password, a telephone number, and the like, the second determiner 136 may determine whether or not a plurality of occupants boarding the subject vehicle M are occupants registered in advance in accordance with input/no-input of passwords, telephone numbers, and the like to the screen.

Next, the second determiner 136 determines whether or not identification of all the occupants boarding the subject vehicle M has been successful (Step S214). For example, in a case in which it is determined that all the occupants boarding the subject vehicle M are occupants registered in advance, the second determiner 136 determines that identification of all the occupants has been successful.

In a case in which identification of all the occupants has not been successful, the first determiner 134 causes the process to proceed to S204 and maintains the communication mode of the communicator 102 as being the information non-provision mode MD2.

On the other hand, in a case in which identification of all the occupants has been successful, the output controller 138 causes the display 110 to display a policy relating to the provision of personal information including the biological information and the position information as a still image or a moving image (Step S216).

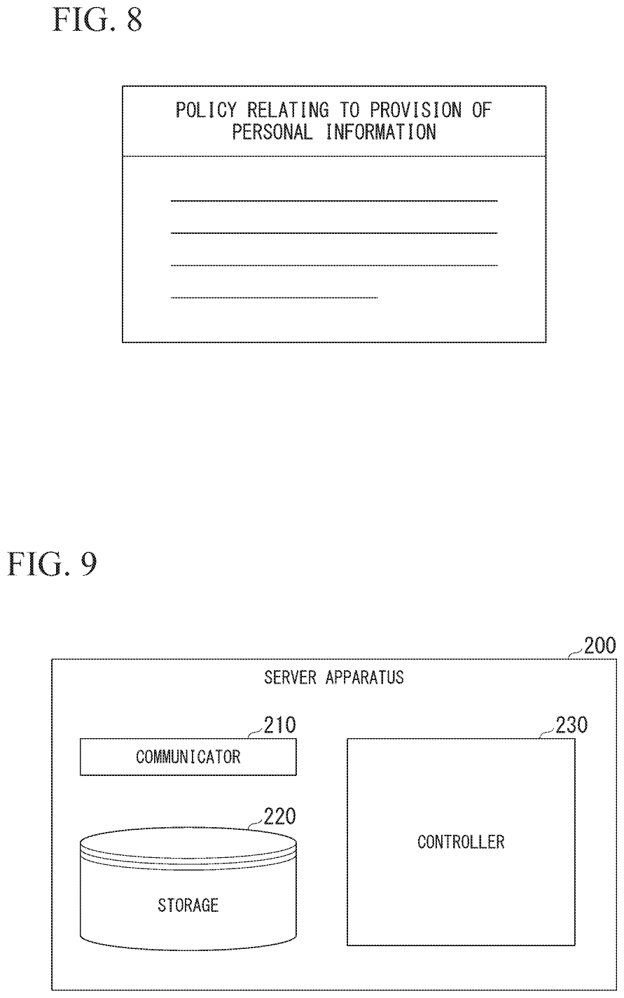

FIG. 8 is a diagram showing one example of a display screen of a policy relating to provision of personal information. The policy relating to the provision of personal information specifies a usage purpose, a usage range, a using method, and the like of provided information in compliance with a privacy protection ordinance, a privacy protection policy, and the like set by each organization. For example, in the policy, provision of biological information and position information that haven been provided to a provider of a vehicle in which the information providing device 100 is mounted (for example, a rent-a-car company or the like), secondary provision of the information from a provider of the vehicle to a third party (for example, a college, a research institute, and the like), and the like are described.

Next, the output controller 138 causes the display 110 to display the provision intention checking screen again, and the second determiner 136 determines whether or not all the occupants have agreed to the provision of the biological information and the position information (Step S218). In a case in which an occupant agrees to the provision of biological information and position information in advance when renting a rent-a-car or registered in car sharing as a member or in a case in which an occupant agrees to the provision of biological information and position information in advance using a smartphone or the like before boarding the vehicle, the process of requesting the occupant to agree to the provision of information inside the vehicle (the process of S202 and S218) may be omitted.

In a case in which one or more occupants have not agreed to the provision of biological information and position information, the first determiner 134 causes the process to proceed to S204 and maintains the communication mode of the communicator 102 as being the information non-provision mode MD2.

On the other hand, in a case in which all the occupants have agreed to the provision of biological information and position information, the first determiner 134 causes the process to proceed to S210 and switches the communication mode of the communicator 102 from the information non-provision mode MD2 to the information provision mode MD1. In this way, the process of this flowchart ends.

In this way, in a case in which a plurality of occupants are boarding the vehicle M, after notifying all the occupants that an incentive is given in accordance with the provision of information, in order to obtain an agreement to the provision of personal information, users of the subject vehicle M can be urged to actively provide personal information. As a result, by analyzing the personal information collected inside the vehicle as big data, development of advanced technologies can be promoted.

### [Configuration of Server Apparatus]

FIG. 9 is a diagram showing one example of the configuration of a server apparatus 200 according to the first embodiment. The server apparatus 200 according to the first embodiment, for example, includes a communicator 210, a storage 220, and a controller 230.

The communicator 210, for example, includes an antenna and a communication interface such as an NIC. The communicator 210, for example communicates with the information providing device 100 mounted in each vehicle through a network NW and communicates with a computer or the like used by a third party such as a research institution.

The storage 220, for example, is realized by an HDD, a flash memory, an EEPROM, a ROM, a RAM, or the like. For example, a program and the like referred to by a processor are stored in the storage 220.

The controller 230, for example, is realized by a processor such as a CPU or a GPU executing a program (software). In addition, the controller 230 may be realized by hardware (a circuit; including circuitry) such as an LSI, an ASIC, or an FPGA or may be realized by software and hardware in cooperation. The program may be stored in the storage 220 in advance or may be stored in a storage medium such as a DVD or a CD-ROM that can be loaded or unloaded and installed in the storage 220 by loading the storage medium in a drive device.

### [Process Flow of Server Apparatus]

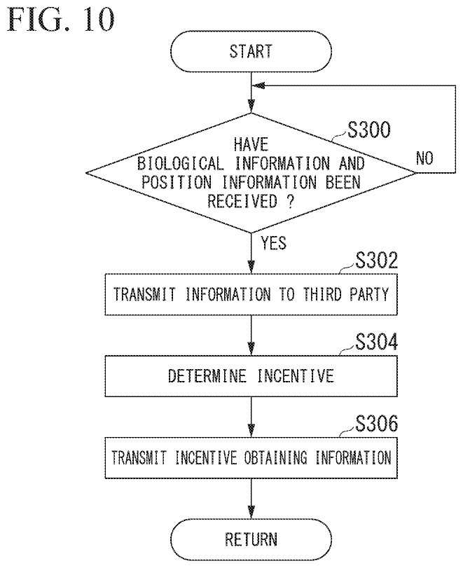

Hereinafter, the flow of a series of processes of the server apparatus 200 according to the first embodiment will be described with reference to a flowchart. FIG. 10 is a flowchart showing the flow of a series of processes of the server apparatus 200 according to the first embodiment. The process of this flowchart, for example, may be performed repeatedly at a predetermined period.

First, the controller 230 waits until biological information and position information are received from the information providing device 100 by the communicator 210 (Step S300). When such information is received by the communicator 210, the controller 230 transmits the biological information and the position information to a computer of a third party through the communicator 210 (Step S302).

Next, the controller 230 determines an incentive to be given to an occupant of a vehicle in which the information providing device 100 that is a transmission source of biological information and position information is mounted, in other words, an occupant who has agreed to the provision of biological information and position information (Step S304).

For example, the controller 230 determines an amount of money to be refunded or points, a discount rate, effective periods of points, a coupon, and the like, and the like on the basis of a length of a period from starting collection of personal information until the collection ends, the number of occupants whose personal information has been collected, and the like. More specifically, as the period of collection of personal information becomes longer, or as the number of occupants whose personal information has been collected increases, the controller 230 increases the amount of money to be refunded or an amount of points, increases the discount rate, and lengthens the effective periods of the points, the coupon, and the like.

Next, the controller 230 transmits information used for notifying that an occupant who has agreed to the provision of information acquires an incentive (hereinafter referred to as incentive obtaining information) to the information providing device 100 that is a transmission source of the biological information and the position information through the communicator 210 (Step S306). In the incentive obtaining information, information of the amount of money, the amount of points, or the like given as an incentive is included. With this, the process of this flowchart ends.

In a case in which incentive obtaining information is received by the communicator 102, the output controller 138 of the information providing device 100 notifies an occupant of the subject vehicle M of obtaining of an incentive by causing the display 110 to display the amount of money, the amount of points, or the like given as an incentive. The server apparatus 200 may transmit incentive obtaining information to a terminal device such as a smartphone held by an occupant who has agreed to the provision of information instead of or in addition to the transmission of the incentive obtaining information to the information providing device 100.

Although an extrinsic motivation has been described as being given such that an occupant agrees to the provision of information by notifying that an incentive is given in the case of agreeing to the provision of information in the first embodiment described above, the form of the motivation is not limited thereto. For example, the information providing device 100 may give an extrinsic motivation such that an occupant agrees to the provision of information by notifying the occupant of the subject vehicle M, to whom an incentive has been given in advance, that the given incentive will disappear, or the effect thereof will reduce (for example, the amount of money to be returned will decrease) unless the occupant agrees to the provision of information. In other words, instead of providing a “positive” motivation of giving an incentive in the case of agreeing to the provision of information, a “negative” motivation of causing the given incentive to disappear unless the occupant agrees to the provision of information may be provided.

According to the first embodiment described above, by including the acquirer 132 that acquires biological information of an occupant of a subject vehicle M and position information of the subject vehicle M, the first determiner 134 that determines a communication mode of the communicator 102 on the basis of an occupant's operation input to the inputter 112, the communication controller 140 that transmits the biological information and the position information acquired by the acquirer 132 to the server apparatus 200 through the communicator 102 in a case in which the communication mode is the information provision mode MD1, and the output controller 138 that causes the display 110 to display a provision intention checking screen notifying that an incentive is given to an occupant when the occupant performs an operation of agreeing to the provision of information or causes the speaker 114 to output a voice indicating that an incentive is given in accordance with the provision of information, a user can be urged to actively provide personal information. As a result, a third party such as a research institution or a company can utilize data that has been approved for the provision of the data to the outside, and accordingly, external cooperation can be actively performed, and development of advanced technologies can be promoted.

### Second Embodiment

Hereinafter, a second embodiment will be described. In the second embodiment, a new user boards the subject vehicle M on the way, which is different from the first embodiment described above. The following description will focus on points different from the first embodiment, and description of points common to the first embodiment will be omitted. In description of the second embodiment, the same reference signs will be assigned to parts that are the same as those according to the first embodiment.

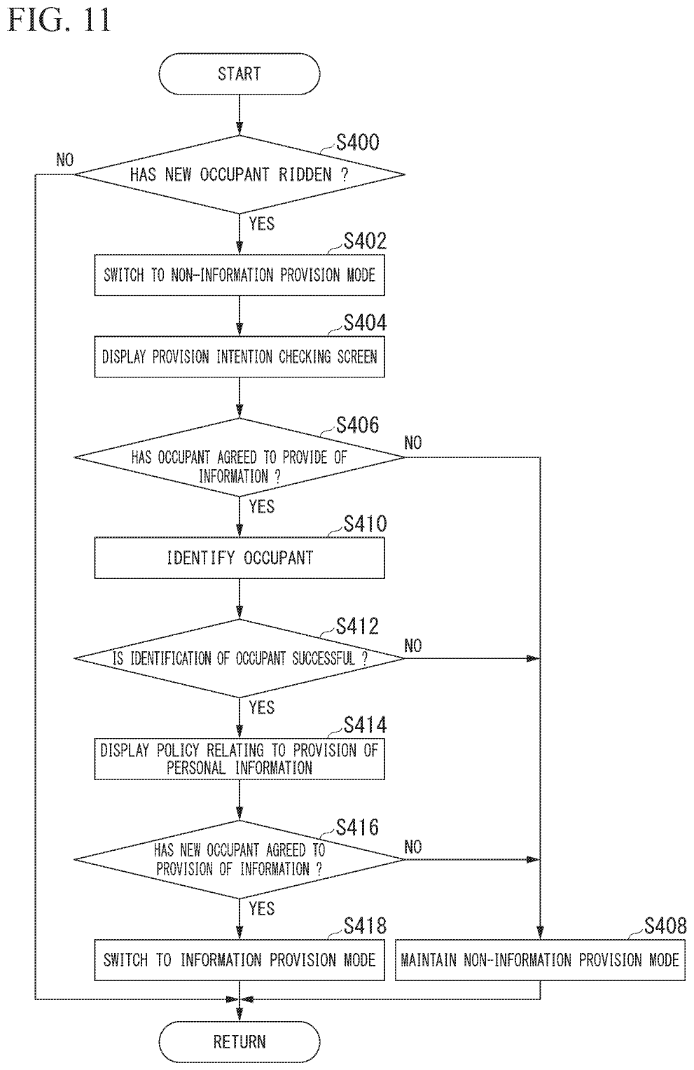

FIG. 11 is a flowchart showing the flow of a series of processes of an information providing device 100 according to a second embodiment. The process of this flowchart, for example, may be repeatedly performed at a predetermined period under a state in which the communication mode of a communicator 102 is the information provision mode MD1.

First, a second determiner 136 determines whether or not a new occupant has boarded a subject vehicle M on the basis of image data and the like acquired by an acquirer 132 (Step S400).

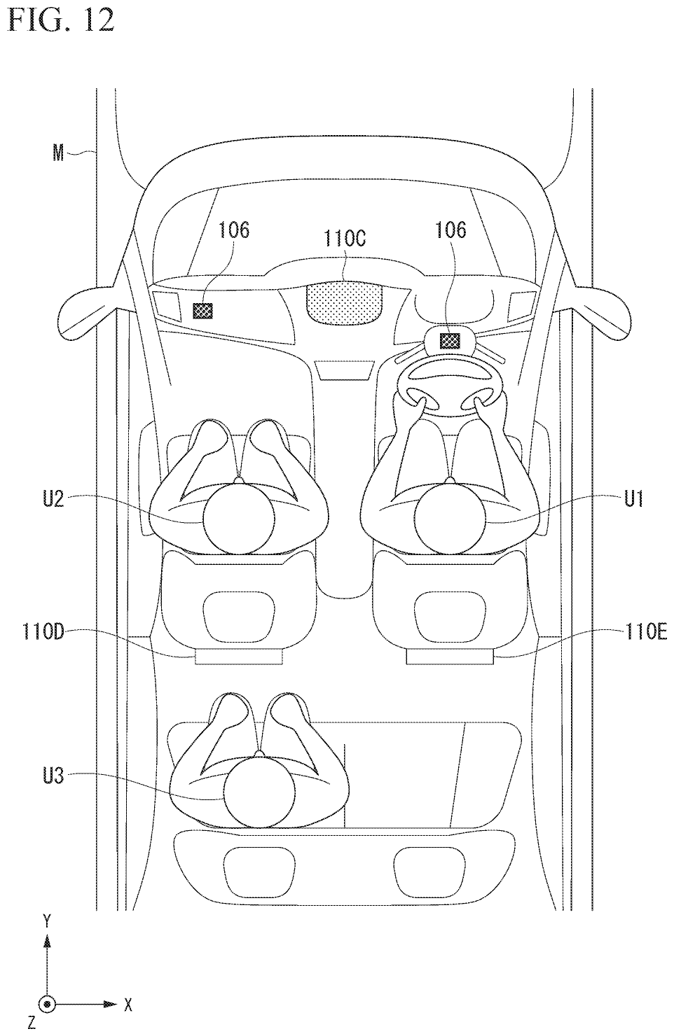

FIG. 12 is a diagram of the vehicle cabin of the subject vehicle M seen from above. In the scene illustrated in FIG. 12, compared to the scene illustrated in FIG. 7, an occupant U3 is additionally sitting on a rear seat. For this reason, the second determiner 136 determines that a new occupant has boarded the subject vehicle M on the basis of image data acquired by imaging the vehicle cabin using a camera 104 and the like.

In a case in which a new occupant has boarded the subject vehicle M, a first determiner 134 switches the communication mode of the communicator 102 from the information provision mode MD1 to the information non-provision mode MD2 (Step S402). In accordance with this, a communication controller 140 does not transmit biological information or position information to a server apparatus 200 through the communicator 102. In a case in which the communication mode is the information non-provision mode MD2, the communication controller 140 may transmit position information to the server apparatus 200. The information non-provision mode MD2 is one example of a “third mode.”

Next, an output controller 138 causes the display 110 to display a provision intention checking screen (Step S404). For example, as in the scene illustrated in FIG. 12, in a case in which a new occupant has boarded the rear seat, the output controller 138 causes the display 110D or 110E that is the closest to the occupant to display the provision intention checking screen.

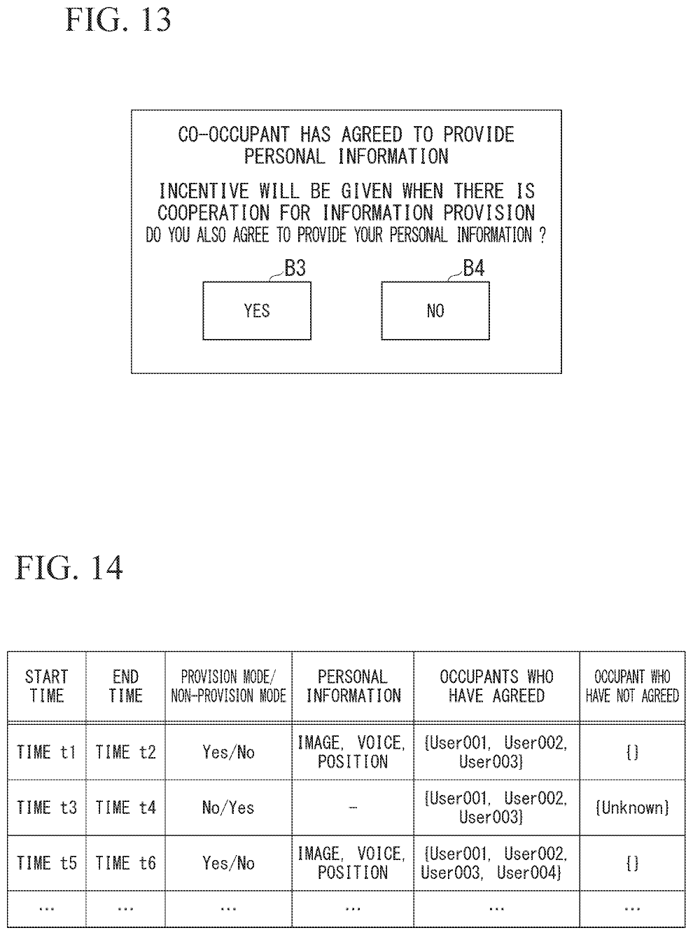

FIG. 13 is a diagram showing one example of a provision intention checking screen displayed toward a vehicle occupant who has newly boarded a subject vehicle M. As illustrated in the drawing, text and images indicating that co-occupants in the subject vehicle M have already agreed to the provision of information, and an incentive will be given when biological information and position information are provided are displayed on the provision intention checking screen.

Next, the second determiner 136 determines whether or not the occupant who has newly boarded the subject vehicle M has agreed to the provision of biological information and position information (Step S406). For example, the second determiner 136 determines that the occupant who has newly boarded the subject vehicle M has agreed to the provision of biological information and position information in a case in which a button B3 used for agreeing to the provision of information is operated on the provision intention checking screen as illustrated in FIG. 13 and determines that the occupant who has newly boarded the subject vehicle M has not agreed to the provision of biological information and position information in a case in which the button B4 used for not agreeing to the provision of information is operated or a predetermined time has elapsed without any button being operated on the provision intention checking screen.

In a case in which the occupant who has newly boarded the subject vehicle M has not agreed to the provision of biological information and position information, the first determiner 134 maintains the communication mode of the communicator 102 in the information non-provision mode MD2 (Step S408).

On the other hand, in a case in which the occupant who has newly boarded the subject vehicle M has agreed to the provision of biological information and position information, the second determiner 136 identifies the occupant who has newly boarded the subject vehicle M (Step S410).

Next, the second determiner 136 determines whether or not identification of the occupant who has newly boarded the subject vehicle M is successful (Step S412).

In a case in which the identification of the occupant who has newly boarded the subject vehicle M is not successful, the first determiner 134 causes the process to proceed to S408 and maintains the communication mode of the communicator 102 in the information non-provision mode MD2.

On the other hand, in a case in which the identification of the occupant who has newly boarded the subject vehicle M is successful, the output controller 138 causes the display 110 (for example, the display 110D or 110E in a case in which the occupant is sitting on the rear seat) to display a policy relating to the provision of personal information as a still image or a moving image (Step S414).

Next, the output controller 138 causes the display 110 to display the provision intention checking screen again, and the second determiner 136 determines whether or not the occupant who has newly boarded the subject vehicle M has agreed to the provision of biological information and position information (Step S416). The output controller 138 may request all the occupants to agree to the provision of information again by causing the displays 110 of all the seats to display the provision intention checking screen in consideration of a relation with the new occupant.

In a case in which the occupant who has newly boarded the subject vehicle M has not agreed to the provision of biological information and position information, the first determiner 134 causes the process to proceed to S408 and maintains the communication mode of the communicator 102 in the information non-provision mode MD2.

On the other hand, in a case in which the occupant who has newly boarded the subject vehicle M has agreed to the provision of biological information and position information, the first determiner 134 switches the communication mode of the communicator 102 from the information non-provision mode MD2 to the information provision mode MD1 (Step S418). With this, the process of this flowchart ends.

FIG. 14 is a diagram showing one example of a history of acquisition of personal information. For example, when image data is acquired from the camera 104 as biological information, voice data is acquired from the microphone as biological information, and position information is acquired from the GNSS receiver 108, the acquirer 132 stores such information in the storage 150 as personal information. At this time, the acquirer 132 stores a start time at which acquisition of personal information started, an end time at which the acquisition of personal information ended, a type of communication mode at a time period from the start time to the end time, identification information of an occupant who has agreed to the provision of information in the time period, identification information of an occupant who has not agreed to the provision of information in the time period, and the like in the storage 150 in association with personal information.

In the example illustrated in the drawing, it is illustrated that an occupant whose identification information is “User004” boards the subject vehicle M at a time t3, and the occupant agrees to provide biological information including image data and voice data and position information at a time t4. In a time period t3 to t4 before the occupant whose identification information is “User004” agrees to the provision of information after boarding the subject vehicle M, the first determiner 134 maintains the communication mode in the information non-provision mode MD2 without switching the communication mode to the information provision mode MD1. In a case in which the occupant (identification information “User004”) who has newly boarded the subject vehicle M agrees to the provision of information, the first determiner 134 switches the communication mode to the information provision mode MD1. In accordance with this, the communication controller 140 transmits personal information including biological information and position information acquired in the time period of a time t5 to a time t6 to the server apparatus 200 by controlling the communicator 102. In a case in which the occupant who has newly boarded the subject vehicle M agrees to the provision of information, and the communication mode is switched to the information provision mode MD1, the communication controller 140 may provide personal information retroactively. For example, in a case in which personal information is acquired in the time period t3 to t4 in which the occupant has not agreed to the provision of information yet, the communication controller 140, in the time period t5 to t6 in which the occupant has agreed to the provision of information, may transmit the personal information acquired in the time period t3 to t4 to the server apparatus 200 together with the personal information acquired in the time period t5 to t6.

According to the second embodiment described above, in a case in which an occupant newly has boarded the subject vehicle M under the information provision mode MD1, the communication mode is switched from the information provision mode MD1 to the information non-provision mode MD2, and the provision of information is temporarily stopped. Then, in a case in which the occupant who has newly boarded agrees to the provision of information, the information provision mode MD1 is restarted. Accordingly, the privacy and the like of the occupant who has newly boarded are respected, and the personal information can be provided to a third party.

### Third Embodiment

Hereinafter, a third embodiment will be described. In the first embodiment or the second embodiment described above, the information providing device 100 has been described as providing personal information including biological information of an occupant and position information of the vehicle for the server apparatus 200. In contrast to this, in the third embodiment, an occupant can freely select data of a provision target, and a use destination of the provided information can be limited, which is different from the first embodiment and the second embodiment described above. The following description will focus on points different from the first embodiment or the second embodiment, and description of points common to the first embodiment or the second embodiment will be omitted. In description of the third embodiment, the same reference signs will be assigned to parts that are the same as those according to the first embodiment and the second embodiment.

An output controller 138 according to the third embodiment causes a display 110 to display a provision intention checking screen and further causes the display 110 to display a screen used for allowing an occupant to select data of a provision target (hereinafter, also referred to as a provision target selection screen) in a case in which the occupant agrees to the provision of information. The provision intention checking screen and the provision target selection screen may not be displayed as different screens and may be simultaneously displayed on the same screen.

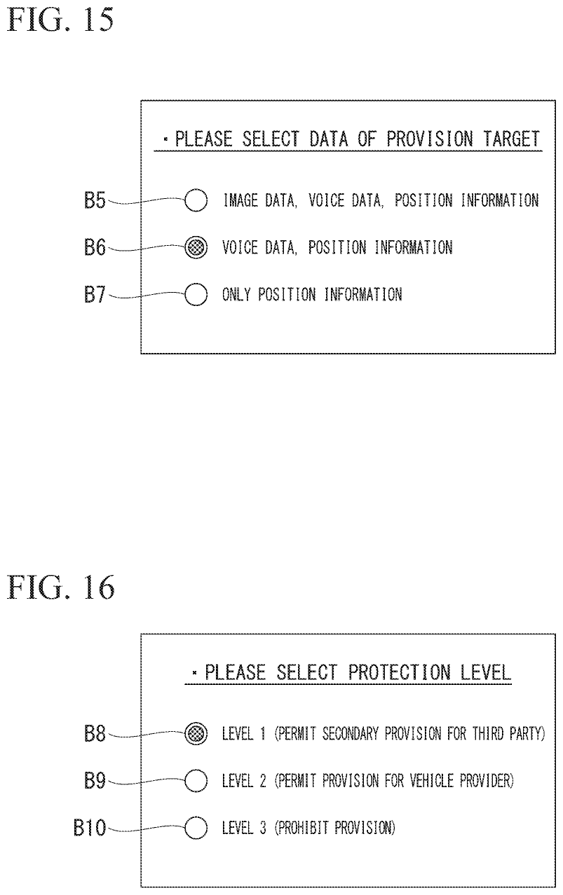

FIG. 15 is a diagram showing one example of the provision target selection screen. As illustrated in the drawing, buttons B5, B6, and B7 are displayed in an operable state on the provision target selection screen. The button B5 is a radio button used for selecting biological information including both image data and voice data and position information as data of a provision target. The button B6 is a radio button used for selecting biological information including only voice data out of the image data and the voice data and position information as data of a provision target. The button B7 is a radio button used for selecting only position information as data of a provision target. For example, in a case in which an occupant who has agreed to the provision of information operates the button B6, the communication controller 140 transmits biological information including only voice data and position information among various types of information acquired by the acquirer 132 to the server apparatus 200 by controlling the communicator 102.

An operation on the button B5 on the provision target selection screen is another example of a “first operation.” and an operation on the button B6 on the provision target selection screen is one example of a “second operation.”

The output controller 138 according to the third embodiment causes the display 110 to display a screen used for selecting a protection level (hereinafter referred to as a protection level selection screen).

Here, a protection level is a level indicating a degree of limiting of the use destination of provided information. For example, level 1 permitting a company of an information provision destination to secondarily provide provided information to a third party, level 2 prohibiting a company of an information provision destination from secondarily providing provided information to a third party, and level 3 prohibiting provision of information to any company, in other words, prohibiting both primary provision and secondary provision, are included as protection levels.

FIG. 16 is a diagram showing one example of a protection level selection screen. As in the example illustrated in the drawing, buttons B8, B9, and B10 are displayed in an operable state on the protection level selection screen. The button B8 is a radio button used for selecting level 1 as a protection level. The button B9 is a radio button used for selecting level 2 as a protection level. The button B10 is a radio button used for selecting level 3 as a protection level. For example, in a case in which an occupant selects one of the buttons B8, B9, and B10, the communication controller 140 transmits information representing the protection level selected by the occupant (hereinafter referred to as level information) and information selected as data of a provision target by the occupant to the server apparatus 200 by controlling the communicator 102. For example, in a case in which an occupant selects the button B9, secondary provision of information provided for the server apparatus 200 to a third party such as a research institute is prohibited. The level information of level 1 is one example of “information for permitting provision of information to a third party.” An operation on the button B8 on the protection level selection screen is one example of a “third operation.”

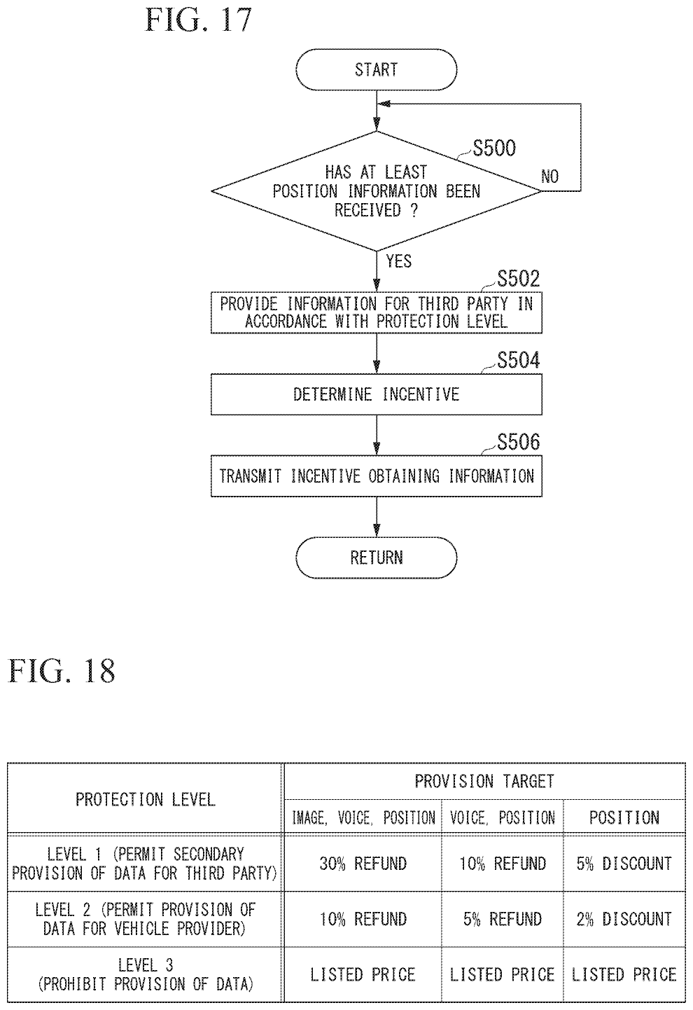

FIG. 17 is a flowchart showing the flow of a series of processes of the server apparatus 200 according to the third embodiment. The process of this flowchart, for example, may be repeatedly performed at a predetermined period.

First, the controller 230 waits until at least position information and level information are received from the information providing device 100 by the communicator 210 (Step S300). When at least the position information and the level information are received by the communicator 210, the controller 230 transmits the provided information to a computer of a third party in accordance with a protection level indicated by the level information (Step S502).

For example, the controller 230 transmits the information provided by the information providing device 100 to a computer of a third party in a case in which the protection level is level 1 and does not transmit the information provided by the information providing device 100 to a computer of a third party in a case in which the protection level is level 2.

Next, the controller 230 determines an incentive to be given to an occupant of a vehicle in which the information providing device 100 that is an information provision source is mounted, in other words, an occupant who has agreed to the provision of information (Step S504).

For example, the controller 230 determines an amount of money to be refunded or an amount of points, a discount rate, effective periods of points, a coupon, and the like, and the like on the basis of a type and a protection level of information selected as data of the provision target in addition to or instead of a length of a period until end of collection after the collection of personal information starts, the number of occupants of which personal information has been collected, and the like.

FIG. 18 is a diagram showing a method of determining an incentive. For example, in a case in which the protection level is level 1, and data of the provision target is biological information including both image data and voice data and position information, the controller 230 determines cash back of cash corresponding to 30[%] of a vehicle usage fee. For example, in a case in which the protection level is level 2, and data of the provision target is biological information including only voice data out of image data and the voice data and position information, the controller 230 determines cash back of cash corresponding to 5[%] of a vehicle usage fee. For example, in a case in which the protection level is level 2, and data of the provision target is only position information, the controller 230 determines a discount of cash corresponding to 2[%] of a vehicle usage fee. In this way, an incentive to be given to an occupant is determined as an incentive that may easily induce the occupant to agree to the provision of information as the number of types of data of a provision target increases. The method of determining an incentive illustrated in the drawing is merely one example and thus may be arbitrarily changed.

An information provision mode MD1 of a case in which data of a provision target is biological information including both image data and voice data and position information is one example of a “first mode”. An information provision mode MD1 of a case in which data of a provision target is biological information including only voice data out of image data and the voice data and position information is one example of a “second mode”. An incentive of a case in which data of a provision target is biological information including both image data and voice data and position information is one example of a “first incentive”. An incentive of a case in which data of a provision target is biological information including only voice data out of image data and the voice data and position information is one example of a “second incentive”.

As illustrated in FIG. 18, the amount of an incentive and the like according to data of a provision target and a protection level may be displayed on the provision target selection screen and the protection level selection screen. In this way, an occupant can select data of a provision target or select a protection level after checking the amount of cash back, a discount rate, and the like.

Next, the controller 230 transmits incentive obtaining information to the information providing device 100 that is an information provision source through the communicator 210 (Step S506). In this way, the process of this flowchart ends.

According to the third embodiment described above, an occupant can determine permission for provision of information for specific data or information among image data, voice data, and position information and can limit a use destination of provided information such as a permission for up to secondary provision for a third party or use only inside a company, and accordingly, a user can perceive a method of utilizing personal information that is used by a company. As a result, a sense of security can be given to the user.

### Fourth Embodiment

Hereinafter, a fourth embodiment will be described. In the fourth embodiment, an information providing device 100 checks details of biological information before providing the biological information and position information for a server apparatus 200 and does not provide the biological information in a case in which inappropriate information of which information provision is refused by an occupant is included in the biological information, which is different from the first to third embodiments described above. Hereinafter, points different from the first embodiment, the second embodiment, or the third embodiment will be focused in description, and description of points common to the first embodiment, the second embodiment, or the third embodiment will be omitted. In description of the fourth embodiment, the same reference signs will be assigned to parts that are the same as those according to the first to third embodiments.

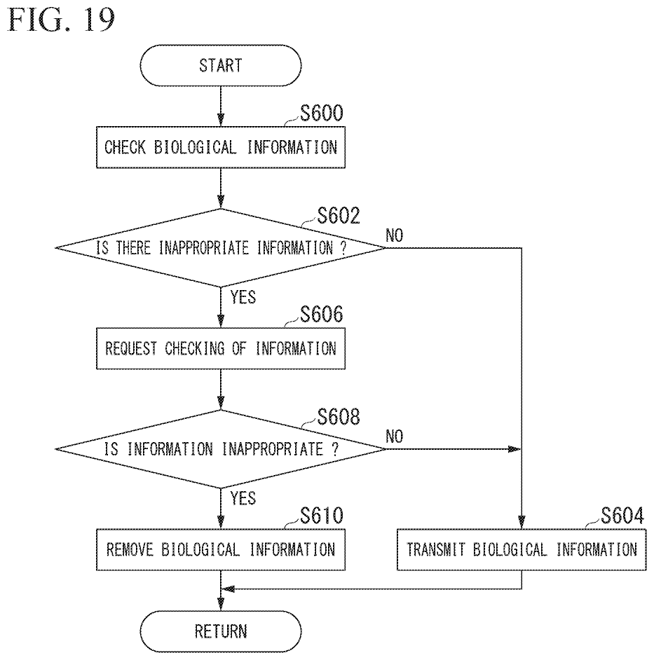

FIG. 19 is a flowchart showing the flow of a series of processes of the information providing device 100 according the fourth embodiment. The process of this flowchart, for example, is performed at a timing at which biological information is accumulated in a storage 150 in units of days, weeks, or months as a batch process.

First, a second determiner 136 checks a plurality of pieces of biological information accumulated in the storage 150 using image processing, speech recognition processing, machine learning, and the like (Step S600) and determines whether or not biological information having a high probability of being inappropriate is included in the plurality of pieces of biological information (Step S602). Here, “biological information having a high probability of being inappropriate” is biological information determined as being inappropriate with a likelihood equal to or higher than a threshold through mechanical processing. For example, voice data when an occupant mentions an address and personal information of other people and image data when a credit card number is shown in a camera 104 are determined as being inappropriate with a high probability. A threshold for a likelihood of being inappropriate may be changed in accordance with a protection level. For example, in a case in which the protection level is level 1, the secondary provision is permitted, and accordingly, the threshold is changed to a threshold for which being inappropriate is more easily determined than level 2 such that inappropriateness is determined more strictly. Biological information having a high probability of being inappropriate is one example of “predetermined information”.

In a case in which biological information having a high probability of being inappropriate is not included in a plurality of pieces of biological information accumulated in the storage 150, the communication controller 140 transmits the plurality of pieces of biological information and a plurality of pieces of position information accumulated in the storage 150 to the server apparatus 200 by controlling the communicator 102 (Step S604).

On the other hand, in a case in which biological information having a high probability of being inappropriate is included in a plurality of pieces of biological information accumulated in the storage 150, the output controller 138 causes biological information to be determined as being inappropriate with a high probability checked by an occupant of the subject vehicle M by causing the display 110 to display image data included in the biological information and causing the speaker 114 to output voice data (Step S606). The output controller 138 may cause the biological information to be checked by an occupant by transmitting biological information determined as being inappropriate with a high probability to a terminal device held by the occupant. Instead of causing biological information determined as being inappropriate with a high probability to be checked by an occupant of the subject vehicle M, the output controller 138 may cause the biological information to be checked by an employee of a company such as a rent-a-car company providing a vehicle in which the information providing device 100 is mounted for a user.

In the case of causing biological information to be checked by an occupant of the subject vehicle M, the output controller 138 may notify the occupant that an incentive is not given without checking of the occupant. In this way, an occupant can be urged to check biological information.

Next, the second determiner 136 determines whether biological information is determined as being inappropriate information by an occupant or an employee who has checked the biological information (Step S608). For example, an occupant or an employee checks biological information determined with being inappropriate with a likelihood of about 80[%] and determines whether or not the biological information is inappropriate or not inappropriate.

In a case in which biological information is determined as not being inappropriate information by an occupant or an employee, the communication controller 140 causes the process to proceed to S604 and transmits a plurality of pieces of biological information and a plurality of pieces of position information accumulated in the storage 150 to the server apparatus 200 by controlling the communicator 102.

On the other hand, in a case in which biological information is determined as being inappropriate information by an occupant or an employee, the communication controller 140 does not provide at least the biological information for the server apparatus 200 but removes the biological information from the storage 150 (Step S610). The communication controller 140 may provide biological information to the server apparatus 200 by highly setting the protection level described above (for example, changing the protection level from level 1 to level 2) instead of removing the biological information.

According to the fourth embodiment described above, by allowing an occupant of the subject vehicle M or the like to check whether or not inappropriate speech or video is included in the information provided for a company or the like, inappropriate information can be inhibited from being provided for a company or the like.

As above, although the forms for performing the present invention have been described using the embodiments, the present invention is not limited to such embodiments at all, and various modifications and substitutions can be applied in a range not departing from the concept of the present invention.

What is claimed is:

1. An information providing device comprising:
an outputter configured to output information;
a communicator configured to communicate with other devices;
an inputter configured to be operated by a user of a vehicle;
a first acquirer configured to acquire biological information of the user;
a second acquirer configured to acquire position information of the vehicle;
a first determiner configured to determine a communication mode of the communicator on the basis of an operation input to the inputter;
a communication controller configured to cause the communicator to transmit the biological information acquired by the first acquirer and the position information acquired by the second acquirer to the other devices in a case in which the communication mode is determined to be a first mode by the first determiner; and
an output controller configured to cause the outputter to output promotion information for urging the user to input a first operation for causing the first determiner to determine the first mode to the inputter.

2. The information providing device according to claim 1, wherein the output controller causes the outputter to output incentive information as the promotion information when the first operation is input to the inputter, the incentive information indicating that an incentive is given to the user.

3. The information providing device according to claim 1, wherein the first acquirer acquires at least one of image information of the user imaged by a camera and voice information of the user received by a microphone as the biological information.

4. The information providing device according to claim 3,
wherein the first mode is a mode permitting transmission of the image information, the voice information, and the position information,
wherein a second mode is additionally included among communication modes in addition to the first mode, the second mode prohibiting transmission of at least one of the image information, the voice information, and the position information, and
wherein the output controller causes the outputter to output first incentive information as the promotion information when the first operation is input to the inputter and causes the outputter to output second incentive information as the promotion information when a second operation for causing the first determiner to determine the second mode is input to the inputter, the first incentive information indicating that a first incentive is given to the user, the second incentive information indicating that a second incentive different form the first incentive is given to the user.

5. The information providing device according to claim 4, wherein types of the first incentive and the second incentive are different from each other.

6. The information providing device according to claim 4, wherein the first incentive is an incentive that more easily induces the first operation than the second incentive.

7. The information providing device according to claim 1,
wherein the first determiner determines the communication mode to be a third mode in a case in which a new user boards the vehicle under the first mode, and
wherein the communication controller causes the communicator to stop transmission of at least the biological information in a case in which the communication mode is determined to be the third mode by the first determiner.

8. The information providing device according to claim 7, wherein the output controller causes the outputter to output promotion information for urging the user who has newly boarded the vehicle to input the first operation to the inputter.

9. The information providing device according to claim 1, further comprising a second determiner configured to determine whether or not predetermined information is included in the biological information,
wherein the communication controller causes the communicator to transmit the biological information and the position information on the basis of a result of a determination according to the second determiner.

10. The information providing device according to claim 1, wherein the first determiner determines the communication mode on the basis of an operation input to the inputter by each of a plurality of users in a case in which the plurality of users are in the vehicle.

11. The information providing device according to claim 1, wherein the communicator controller causes the communicator to transmit the biological information, the position information, and information for permitting information provision for a third party in a case in which a third operation permitting provision of at least one of the biological information and the position information for the third party other than a provider that has provided the vehicle for the user and the third party is input to the inputter.

12. An information providing method using a computer mounted in a vehicle including an outputter configured to output information, a communicator configured to communicate with other devices, and an inputter configured to be operated by a user of a vehicle, the information providing method comprising:
acquiring biological information of the user;
acquiring position information of the vehicle;
determining a communication mode of the communicator on the basis of an operation input to the inputter;
causing the communicator to transmit the biological information and the position information to the other devices in a case in which the communication mode is determined to be a first mode; and
causing the outputter to output promotion information for urging the user to input a first operation for determining the first mode to the inputter.

13. A computer-readable non-transitory storage medium storing a program causing a computer mounted in a vehicle including an outputter configured to output information, a communicator configured to communicate with other devices, and an inputter configured to be operated by a user of a vehicle to execute:
a process of acquiring biological information of the user;
a process of acquiring position information of the vehicle;
a process of determining a communication mode of the communicator on the basis of an operation input to the inputter;
a process of causing the communicator to transmit the biological information and the position information to the other devices in a case in which the communication mode is determined to be a first mode; and
a process of causing the outputter to output promotion information for urging the user to input a first operation for determining the first mode to the inputter.
